(19) United States
(12) Patent Application Publication
(10) Pub. No.: US 2021/0028950 A1
(43) Pub. Date: Jan. 28, 2021

(54) MULTIDIRECTIONAL MAGNETIC FIELD AREA READER SYSTEM WITH FEATURES

(71) Applicant: LEXMARK INTERNATIONAL, INC., Lexington, KY (US)

(72) Inventor: KEITH BRYAN HARDIN, LEXINGTON, KY (US)

(21) Appl. No.: 17/071,759

(22) Filed: Oct. 15, 2020

Related U.S. Application Data
(63) Continuation-in-part of application No. 16/429,710, filed on Jun. 3, 2019, now abandoned.

(51) Int. Cl. H04L 9/32; G01R 33/12; G09C 1/00

(52) U.S. Cl. CPC H04L 9/3278; H04L 9/0866; G09C 1/00; G01R 33/1276

(57) ABSTRACT

A system for use in authentication processes is described comprising a physical unclonable function (“PUF”), a substrate, a plurality of magnetized particles randomly dispersed in the substrate, a PUF reader constructed using multiple discrete magnetometer chips that have magnetic field sensors. The measured magnetic field data may be compared to previously enrolled data to assess authenticity.

### CROSS REFERENCES TO RELATED APPLICATIONS

This application claims priority and benefit as a continuation-in-part application of U.S. patent application Ser. No. 16/429,710, titled “Magnetometer Chip Sensor Array for Reading a Magnetic PUF, Including a Magnetic PUF Film or Tape, and Systems Incorporating the Reader,” having a filing date of Jun. 3, 2019. This application also claims priority and benefit as a continuation-in-part application of U.S. patent application Ser. No. 17/017,086, titled “Cryptoanchor Reader,” having a filing date of Sep. 10, 2020. This application also claims priority and benefit under 35 U.S.C. 119(e) from U.S. provisional application No. 62/916,029 titled “Multidirectional Magnetic Field Area Reader System With Features,” having a filing date of Oct. 16, 2019.

### BACKGROUND

### 1. Field of the Invention

This invention relates generally to sensor arrays for capturing physically measurable characteristic of physical unclonable function (“PUF”) objects created by molding specialized particles into a resin or matrix. and more particularly, to a PUF reader devices that incorporate the sensor arrays.

### 2. Description of the Related Art

U.S. Pat. No. 9,553,582, incorporated herein by reference, discloses a PUF (Physical Unclonable Function) that contains magnetic particles, which generate a complex magnetic field near the surface of the PUF part. This magnetic field may be measured along a path and data corresponding to the magnetic field components recorded for later comparison and authentication of the PUF part. U.S. Pat. No. 9,608,828, incorporated herein by reference, discloses the advantages of magnetizing the feed stock prior to the injection molding process to achieve a random orientation of the magnetization directions. In these patents, flakes of an NdFeB alloy are cited as the preferred magnetic particles, however other magnetic materials, alloys, and particle shapes may be employed. These flakes are typically about 35 microns thick with irregular shapes varying in width from 100-500 microns but may vary substantially from these ranges. The NdFeB alloy is not easily magnetized because it has an intrinsic coercivity of around 9,000 Oersted. However, once magnetized, the alloy has a residual induction of about 9,000 gauss, and the random locations and magnetic orientations of the particles and flakes produce sharp peaks in the magnetic field strength of ±10-30 gauss when measured at a distance of about 0.5 mm from the surface of the PUF.

The magnetic PUF technology can be applied to create PUF tags for authenticating passports, secure ID cards, and other non-rotating objects. For these applications, the complex magnetic field structure near the surface of a magnetic PUF, measured over a non-rotating 2-dimensional region can serve as a magnetic “fingerprint.” A low cost means of authenticating the magnetic PUF fingerprint is needed for non-rotating systems that read stationary or translating PUFs. In a rotating PUF sensor system a single sensor can measure the magnetic profile values at multiple angles around a circular path through the PUF fingerprint. This is possible using a single 3-axis Hall effect sensor because the rotation of the PUF element enables the fingerprint to be sampled at a high spatial frequency using a single magnetometer chip. For non-rotating PUF systems with no moving parts, the sampling of the magnetic fingerprint at multiple locations requires multiple magnetic field sensors, or movement of the PUF with respect to the sensors (similar to a credit-card swipe). A resolution of at least 0.1 gauss is preferred given the expected signal amplitudes generated by PUF samples.

### SUMMARY OF THE INVENTION

As shown in FIG. 1, the Z-component of a representative magnetic PUF fingerprint does not change significantly over 0.1-0.2 mm of travel along the surface of the PUF. This is because the Hall-effect sensor or sensing element in this example is about 0.5-1.0 mm above the magnetized flakes generating the magnetic field. An economical array of Hall-effect sensors for sampling and validating the magnetic fingerprint would have the sensors nominally spaced approximately at least 0.4 mm apart for the flake sizes discussed in the related art. The average flake length for this approximation is 0.3 mm. The ratio of the minimum separation to particle length is approximately 1.33.

Unique Physical Unclonable (PUF) function objects may be created by molding or extruding specialized particles creating a measurable physical characteristic over a surface. The PUF may be pre-magnetized or post-magnetized particles into a resin or matrix. The pre-magnetized particles form a unique measurable magnetic “fingerprint” based on the random size, position, polar rotation, magnetization level, particle density, etc., of the particles. PUF objects may also vary in other physical characteristics by having a mixture of magnetic, conductive (magnetic or nonmagnetic), optically reflective or shaped, varied densities or mechanical properties resulting in random reflection, diffusion, or absorption of acoustical energy particles in a matrix or binder. The present invention envisions sensing any of the characteristics.

A low cost PUF fingerprint reader can be constructed using multiple discrete 3-axis magnetometer chips. A 1.46 mm×1.46 mm wafer level chip size package, for example, could be placed on a circuit card with a 2 mm center-to-center spacing. This will enable the placement of a 5×5 array of 3-axis Hall-effect sensors within a 10 mm×10 mm window in this example, which would result in the sensing locations spanning an 8 mm×8 mm window for such an arrangement.

### BRIEF DESCRIPTION OF THE DRAWINGS

Having thus described the invention in general terms, reference will now be made to the accompanying drawings, which are not necessarily drawn to scale, and wherein:

FIG. 1 shows the Z-component of a representative magnetic PUF fingerprint.

FIG. 2 shows a printer cartridge with PUF material attached.

FIG. 3 shows a reader device with a sensor array.

FIG. 4 shows a reader element that has two sections.

FIG. 5 shows a reader with two separated sections.

FIG. 6 shows a bottom isometric view of a PUF reader device.

FIG. 7 shows a top isometric view of a PUF reader device adjacent to a PUF.

FIGS. 8 and 9 show exploded views of a PUF reader device.

FIG. 10 shows possible optical responses to a high entropy taggant.

FIG. 11 shows an example of real-time, raw 3-axis magnetometer reported by iOS.

FIGS. 12A, 12B, 13A, 13B, 14A, and 14B show hand-held reader devices.

FIG. 15 shows a wrist or forearm reader device.

FIG. 16A, 16B, and 16C show a rotatable reader design with a plurality of magnetometers.

FIGS. 17 and 18 show a sensory array or CMOS array.

FIG. 19 shows embodiments using a native mobile phone device.

FIGS. 20A-C, 21A-B, and 22A-B, 23A-C, 24A-B, and 25 show reader designs that are worn or held by the user.

FIG. 26 shows the electronic major blocks.

FIG. 27 shows locations of discrete magnetic field sensors in the context of a PCBA with array of 3D hall effect sensors.

FIG. 28 shows an array of discrete or dual Hall effect sensor on a PCB.

FIG. 29 shows a 1D-axis magnetic field camera.

FIGS. 30A and 30B shows a VCR head that has 3D inductive pickup coils.

FIG. 31 shows a mechanical system consisting of several blocks that can work in conjunction with each other.

FIGS. 32A-H show possible features in the surface of an object to be used to either align the object to the sensor or be an interlocking mechanism.

FIGS. 33A and 33B show a MEMS device for measuring a force pattern.

FIGS. 34A-C show a removable reader, the reader mounted to an articulating arm, and modular reader mounted on a frame for connecting to a mobile phone

FIGS. 35A and 35B show a spring action method to promote equal pressure of the sensor to object.

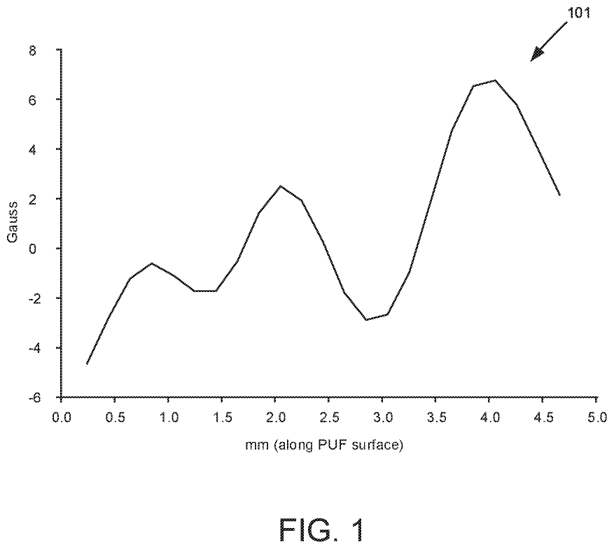

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology, terminology and dimensions used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art. The dimensions of the magnetic particles, separations between particles and sensor locations are interrelated and can be proportionally scaled with respect to each other to provide different dimensional solutions.

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

One of the challenges of using multiple sensor chips is the manufacturing tolerances on the exact physical locations of the Hall effect sensor elements within the assembled PUF read head. The chip packages can typically be placed with ±0.05 mm accuracy. Further, the sensing elements have ±0.05 mm tolerances within the chip packages for each dimension. Therefore, the uncertainty in the relative measurement location of a given sensor is ±0.1 mm. Uncertainty of the relative x and y spacings can be reduced by x-raying the chip array to measure the sensor element positions in X-Y coordinate directions. A less expensive method would be to use a calibration fixture to accurately scan a PUF object over an X-Y coordinate window that is larger than the nominal distance (center-to-center) between the sensor chips. The overlapping data from adjacent sensors can be used to determine the relative locations of the sensor elements.

A computer simulation was conducted to investigate how many sensors are required in an array to achieve a desire confidence level that the test result is not a false positive. In the simulations, the fingerprint enrollment data was recorded over the PUF surface at 0.1 mm intervals in both the X and Y coordinate directions. Further, the height Z of each sensor chip varies randomly ±0.05 mm. When a PUF read head array is brought into contact with an enrolled PUF tag to measure its fingerprint, the location of the validation sensor array is assumed to be aligned with the enrollment data window within ±1 mm. A correlation algorithm testing the simulated validation readings against the enrollment fingerprint map by calculating the Pearson correlation R-value for each component of the magnetic field and multiplying the components together, i.e., Rx_{xyz}=Rₓ*R_{y}*R_{z}. This correlation is preferred for multiple array locations within the fingerprint enrollment data. Any other suitable statistical analysis could be used to compare the validation readings to the enrollment values.

Typically, when the magnetic sensors are more than 1 mm apart, the magnetic field values at each sensor location essentially becomes independent variables. If only one sensor is used to authenticate the magnetic field, the probability is high that a match to that sensor's magnetic field readings can be found along the X and Y coordinate dimensions in the enrollment data. With multiple magnetic sensors separated by known distances along the X and Y coordinate dimensions, the probability of finding a false positive match is reduced. If the probability were to be only reduced to 0.01, then a counterfeiter could produce hundreds of PUF parts and test the set to collect the ones that happened to be accepted by the validation algorithm. A much lower probability of a false positive outcome is needed to make this counterfeit strategy cost prohibitive.

To assess the probability of a counterfeiter producing a random match, hundreds of simulations were run for magnetic PUF readers using 4, 5, 6, 7, 8, 12, 16, 20, and 24 magnetic sensors (3-axis) to generate estimates of the probability of a random match (a false positive). In these simulations the magnetic sensors were nominally spaced 2 mm apart. Statistical analysis of the hundreds of validation scores showed that an array of 4 sensors (3-axis) would produce a passing test result about 8.20E-02, i.e., 8.20% of the time. This arrangement does not provide a high confidence level that the “passed” item is authentic. Increasing the number of sensor locations to 5 would produce a false positive about 4.20% of the time. Table 1 shows the probability of generating validation scores above 0.7 using the Pearson correlation R-value, R_{XYZ}, when testing random PUF parts. Analysis of the log of the probabilities confirms that it is a linear function of the number of sensors.

One approach to decreasing a random match without increasing the number of sensors is if the PUF reader measures the fingerprint, moves at least 0.5 mm and takes a second measurement. The probability that both authentication scores are above 0.7 using the Pearson correlation R-value are shown in the third column. Statistical analysis showed that an array of 4 sensors (3-axis) would produce a passing test result about 0.672% of the time if a second measurement was taken. While the probability of passing a random PUF part are significantly reduced, this places a burden on the user to move the reader and take a second measurement of the magnetic fingerprint. Similarly, mechanical means could be employed to automatically shift the PUF reader sensor array by 1 mm at an added cost.

TABLE 1

| | Probability (Pearson | Probability (Two Pearson |
|---|---|---|
| # | Correlation R-Value | Correlation R-Value |
| Sensors | score > 0.7) | scores > 0.7) |
| 4 | 8.20E−02 | 6.72E−03 |
| 5 | 4.20E−02 | 1.76E−03 |
| 6 | 8.00E−03 | 6.40E−05 |
| 7 | 1.30E−03 | 1.69E−06 |
| 8 | 8.00E−05 | 6.40E−09 |
| 12 | 4.00E−09 | 1.60E−17 |
| 16 | 1.20E−12 | 1.44E−24 |
| 20 | 4.30E−18 | 1.85E−35 |
| 24 | 1.10E−21 | 1.21E−42 |

Given the low cost of magnetic sensor chips, the preferred implementation would be to use a PUF reader with more sensor chips in the reader head to achieve the same confidence level as measured here by the Pearson correlation R-value. It should be noted that if the magnetic sensors do not perform measurements of all three orthogonal axes of the magnetic field, that one would need additional sensor measurements to compensate for the reduced information coming from each sensor.

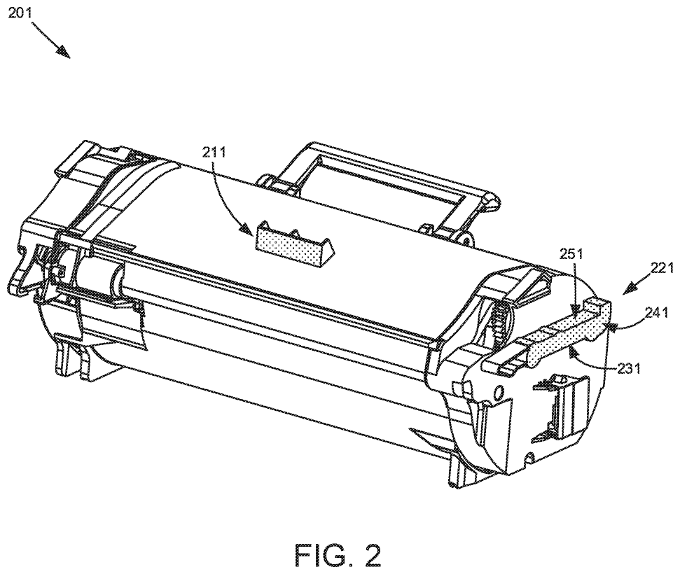

Referring to FIG. 2, a printer cartridge 201 is shown with PUF material attached on features 211 and 221. This PUF material can be made in various thicknesses from a fixed block to a thin tape. The PUF may be applied onto the surface or molded into the supply item.

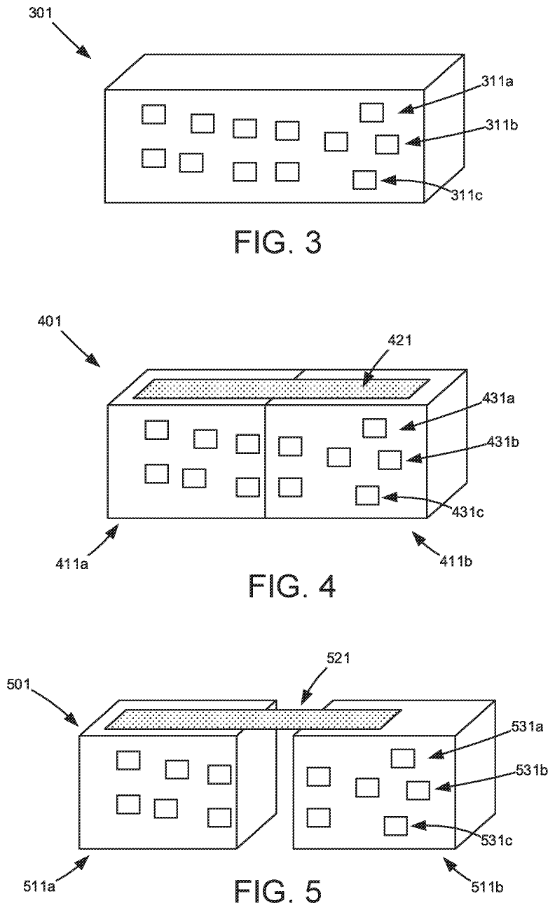

A reader device 301 is shown in FIG. 3 with multiple sensors 311a, 311b, and 311c are shown, for example, that come in close proximity to the PUF surfaces. The number of sensor locations, a total of twelve (12) are shown on the reader device in FIG. 3, is determined by the level of security needed for the application that can provide a secure authentication of the printer cartridge, in this instance.

The reader may contain an array of sensors arranged on a flat surface that may be in any pattern. The sensors must be nominally spaced a minimum distance apart to give significantly different field values. A preferred separation would be approximately 1 mm, but this distance is not limiting. The accuracy of each sensors known relative location in the sensor array is necessary as described above. The preferred ratio of the spacing to the particle length is 3.33, but this ratio is not limiting.

The reader in FIG. 3 could be used for both PUFs attached at 211 and 221 in FIG. 2. The reader is not limited to a specific surface, however. The PUF at 221 has three surfaces available for reading (bottom 231, side 241, and top 251). Moreover, the reader could wrap around the three sides as long as their relative positions are known/predetermined from the sensor calibration.

As discussed above, the number of sensors can be reduced if more locations are measured by discrete movements of the sensors. This can be done by adding an actuation system to the reader, whether mechanical or electromechanical, for example.

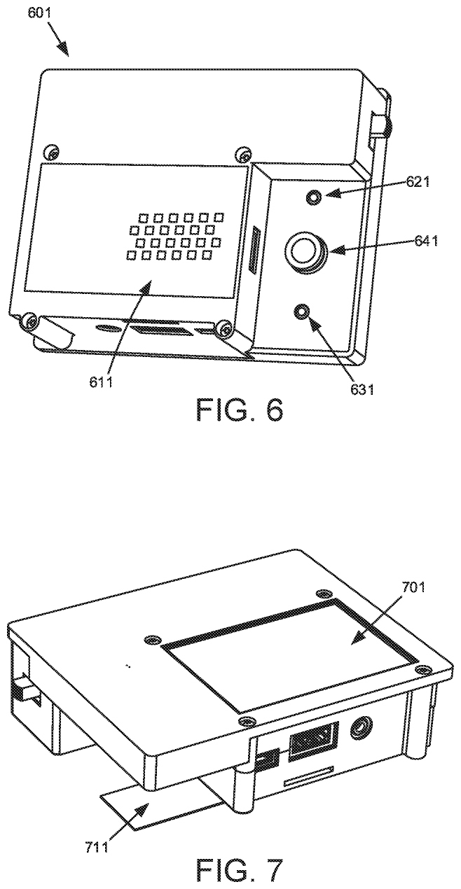

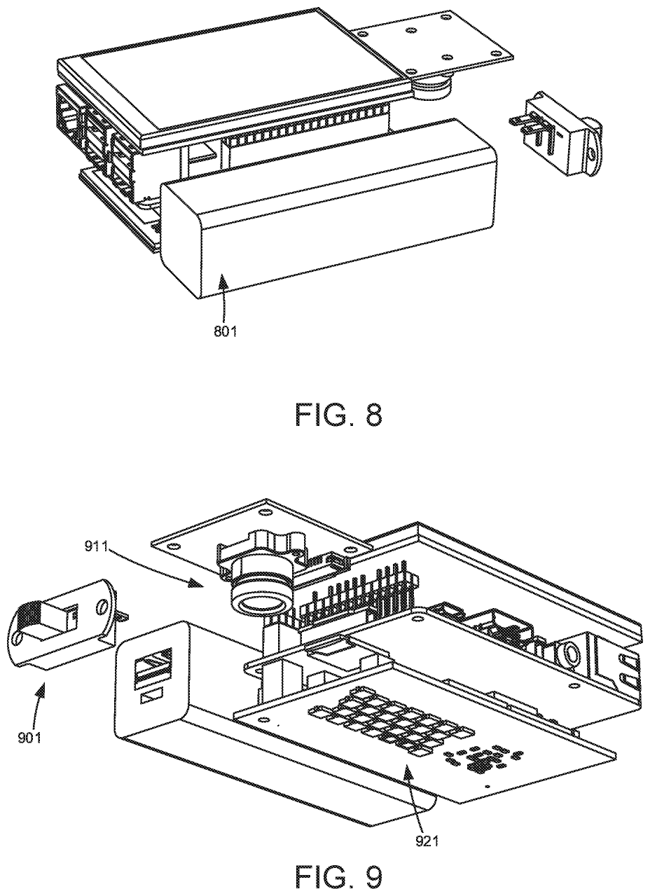

FIG. 4 shows a reader element that has two sections, 411a and 411b. Each section has an array of sensors, such as, e.g., 431a, 431b, and 431c that can be located adjacent if the sections abut as in FIG. 4 or separated by a fixed distance determined by a connecting element 521 as in FIG. 5, which shows two separated sections, 511a and 511b. Each separated section has an array of sensors, such as, e.g., 531a, 531b, and 531c. The adjacent mode in FIG. 4 has 12 sensor locations. If both sets of sensor faces are allowed to move during the authentication measurement a distance greater than the minimum separation distance from the adjacent mode in FIG. 4 then this adds another 12 sensor locations, thus increasing the security level.

An example embodiment of a reader with two sections is that on a printer for a cartridge with a magnetic PUF that is inserted and removed by the user. A simple mechanical cam or lever action as is known to persons of ordinary skill in the art can push the sections together during the forward motion and apart with reverse motion. Another embodiment would be to use the cover door of a printer to actuate the assembly between adjacent, FIG. 4, and separated, FIG. 5.

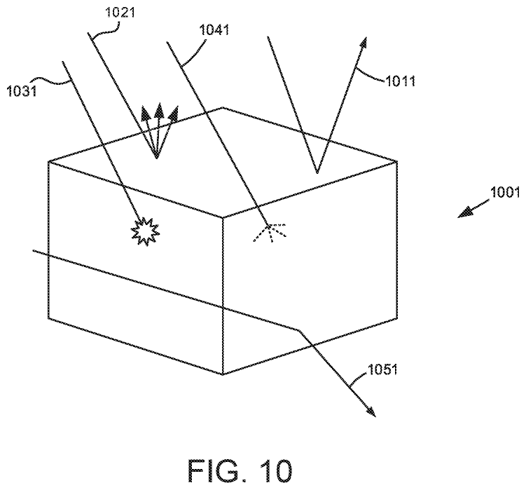

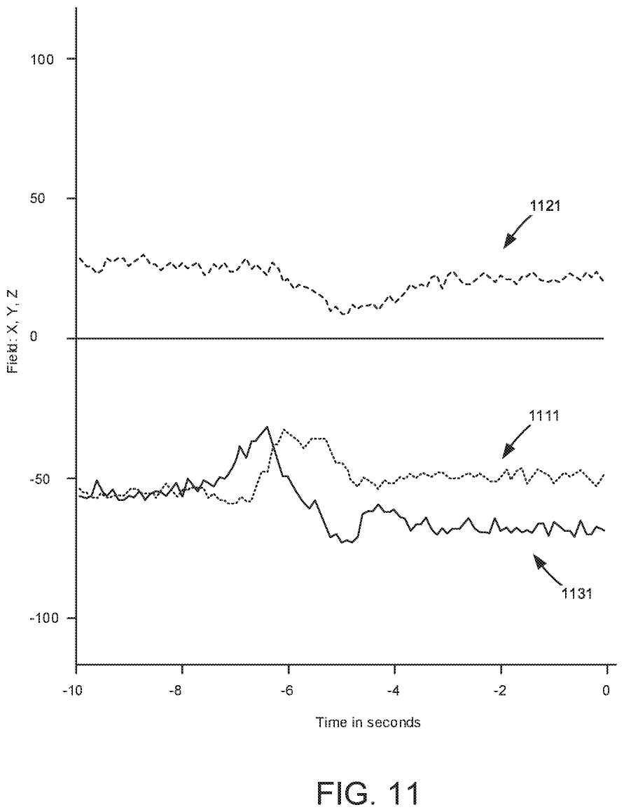

Referring to FIG. 6, a PUF reader device 601 that may incorporate the reader elements of FIGS. 3, 4, and 5 is shown. A sensor array 611 is positioned on the bottom of the reader device 601. The sensor array 611 may be potted with epoxy resin or other polymer material to protect it from interference/damage by static electricity, dirt, or other factors. As shown in FIG. 7, by positioning the array on the bottom of the device, it may be placed in close proximity (contact) to a PUF 711. In FIG. 7, the PUF element is a film or tape, that is made by extrusion processes, and is preferably a thickness between is 0.05 mm to 1.50 mm. With a suitable adhesive backing (not shown), a section of PUF tape can be applied to the surface of an element to be identified. However, other PUF elements may be used instead of a tape. Further, the PUF element may be used in conjunction with a local, associated non-volatile memory, wherein the non-volatile memory contains magnetic field profile data measured from the magnetized particles. The magnetic field profile data could also be stored online or in a cloud location for later access. Further, data stored online or in the cloud location may correspond to bar code or QR code data use to the select the associated enrollment data.

The magnetized particles may contain neodymium and iron and boron, or other compounds such as samarium and cobalt, or any other magnetic materials that would produce a measurable magnetic field.

The PUF reader device 601 may have a camera or other viewing element 641, to assist in positioning the device, read a Quick Response (“QR”) code or other identification mark, orient the device with respect to fiducials, or otherwise provide an optical orientation of the PUF 711. A viewing display, 701, allows the user to view the image captured by the camera lens. The viewing display, 701, may also be a touchscreen for operation of the PUF reader device 601. Lighting elements, 621 and 631, such as LED or other appropriate lighting, illuminate the camera image.

The image sensor may be a complementary metal-oxide-semiconductor (CMOS) or a semiconductor charge-coupled device (CCD) or other similar device to measure an image or optical reflectance from the PUF material.

Optionally, a viewing element, lighting, and display can be removed, and physical features such a guide edges (not shown), or other appropriate element, can be used to orient the PUF reader device 601 and the PUF 711.

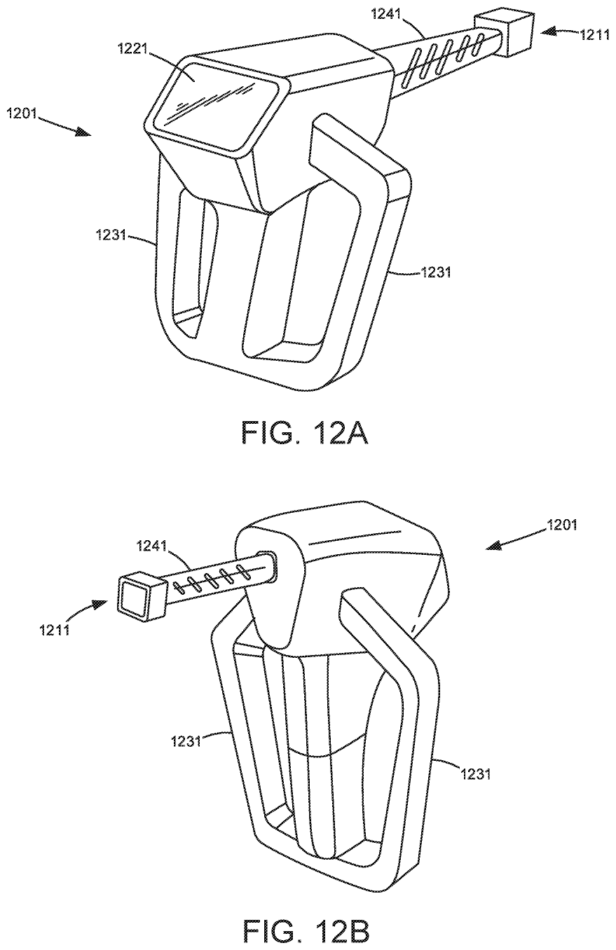

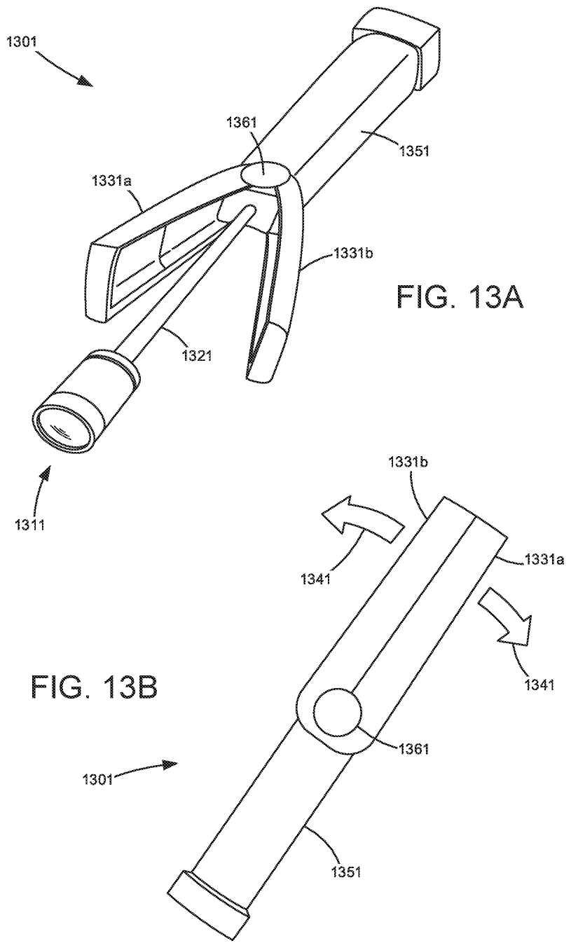

The PUF reader device, as shown in the exploded views in FIGS. 8 and 9 can be either battery powered 801 or other power supply.

This invention captures novel concepts related to a “CryptoAnchor” reader, i.e., the element that can sense the contents of a CryptoAnchor and submit data for authentication. The reader may exist in multiple forms and employ more than one sensing type simultaneously. The first embodiment of a “CryptoAnchor” is that of pre-magnetized particles suspended in a polymer binder. The reader would have a plurality of magnetic sensing elements in an array.

The magnetic sensing array is composed of discrete, three-axis Hall Effect devices mounted to a printed circuit board (PCB) as closely as allowable by the chip package. A limitation of this approach is the low spatial density of sensors achievable. An integrated sensor array that has very high spatial density compared to discrete chips on PCB and sensing element near surface may be preferable. A magneto-optical feature may also be desirable.

While there exist techniques for measuring magnetic fields, the CryptoAnchor tag is intended to create magnetic fields with an absolute value of typically between 0 and 100 Gauss. The reader is not intended to perform authentication, but to sense characteristics and communicate the measured information to another device that calculates comparison. The results of the comparison may then be displayed on the reader. The communication methods could be wired (e.g., Ethernet) or wireless (e.g., WiFi, Cellular).

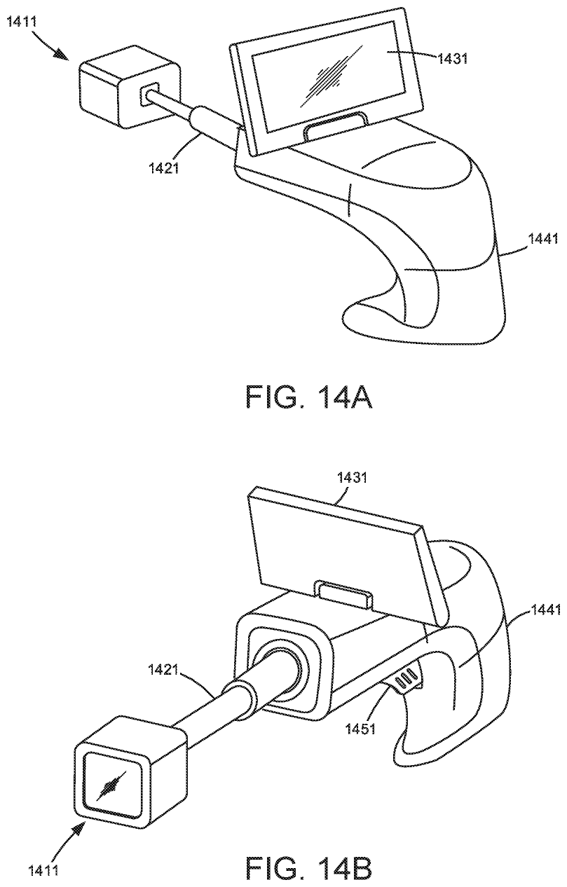

In addition to the magnetic characteristics, depth and layering of high entropy taggants provides more degrees of freedom (DOF) to be measured to assure authenticity. For example, higher DOF enables more customization of tag for size, shape, brand, error checking, hashing, uniqueness, clonability, etc. High entropy taggants 1001, see FIG. 10, might include, for example, optical properties such as specular reflection 1011, diffuse reflection 1021, absorption 1031, scatter 1041, and transmission 1051, including, but not limited to human visual. Emerging miniaturized hyperspectral systems may provide additional optical and non-optical sensor options.

High entropy taggants may further include materials that are fluorescent or phosphorescent. Use of these materials is practiced in biological sciences, analytical chemistry, and forensics.

Barcode and radio frequency (RF) are common, growing means to track-and-trace items in a supply chain. Each technology is easily copied but when combined with a plurality of high entropy taggants and means to read each layer independently would enable depth and customization.

The invention described has a magnetic taggant but allows for the strategic architecture of a system to practice a wide variety of taggants, potentially simultaneously, depending on the application. A market example where layering is conspicuous is the paper currency market, where, e.g., the U.S. $100 bill contains approximately twenty different features of overt, covert, and forensic nature.

The U.S. Department of Defense provides an example of authenticity requirements in response to congressionally-mandated service parts authentication improvements that seek a solution to prevent the use of counterfeit integrated circuit (IC) items in DoD equipment. DoD Solution RFQ requires: (1) minimal disruption to existing supply chain; false positive rate of less than 1/1012; false negative rate of less than 1/104; authentication in less than 10 sec; area of tag less than 64 mm2; additional IC height less than 1 mm; all data able to be hosted by DoD; cost of the tag less than $50; and cost of the reader less than $50,000.

A solution described here that meets these requirements is an 8×8 mm magneto-optical device over-molded into the chip cap with a reader that simultaneously, but independently, measures the three-axis magnetic signature, encrypts, transmits to a first server over cellular link and captures high resolution RGB/UV image, encrypts, transmits to a second server over Wi-Fi link. A comparison can be made on each server with a logical AND at point of measurement to verify the authenticity of critical integrated circuits.

In a second example, high-end consumer goods makers with exclusive brands seek differentiated authentication solutions to further branding. A solution is to integrate a near-field communication (NFC) tag with magnetic tag into the logo of the branded product. Such NFC tags can be interrogated with mobile phone and a branded application. A branded, magnetic tag reader located conspicuously at point-of-sale, can provide authentication for the consumer.

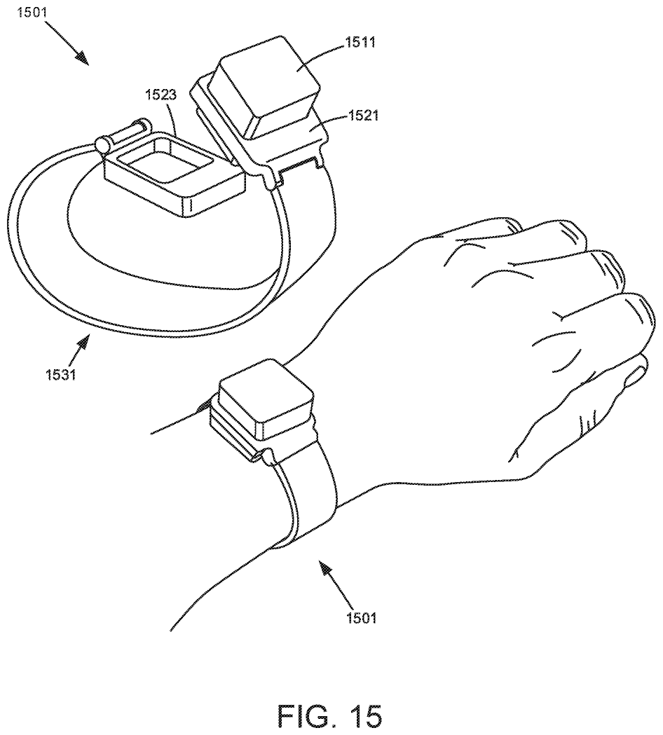

The proliferation of mobile devices, intrinsic sensing, and defined interfaces for peripheral demand enables a reader based around a mobile device. To allow a mobile device to function as a compass, largely used for navigation functions, it must contain a magnetometer. FIG. 11 shows an example of real-time, raw 3-axis magnetometer reported by iOS, with the X-Field 1111, Y-Field 1121, and Z-Field 1131. Mobile devices may have: (1) on the front—RBG camera, infrared (IR) sensor, a structured light projector, and a high pixel density display, that could be used as a light source; (2) on the rear—RGB camera(s), and a flash; and (3) communications capabilities, including—cellular, WiFi, Bluetooth, Bluetooth Enabled, NFC, and RFID.

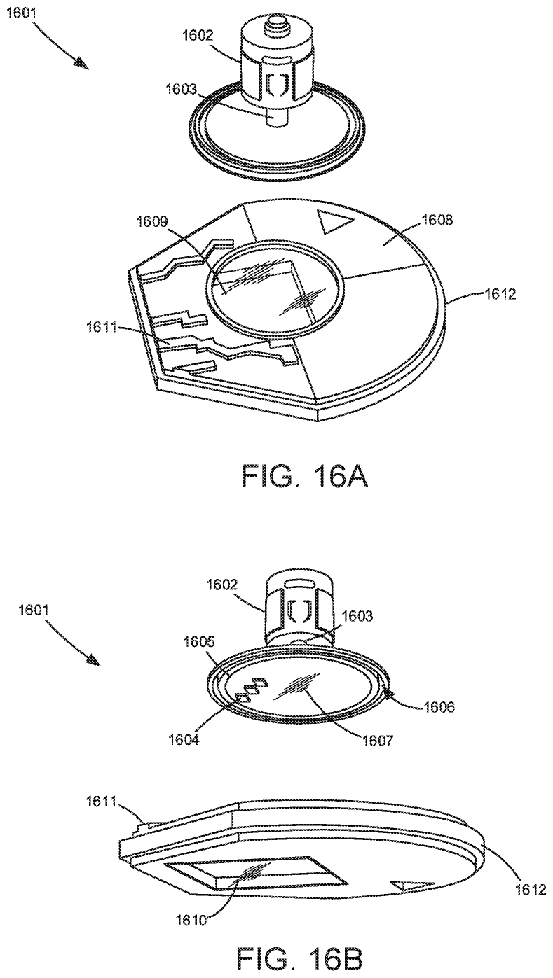

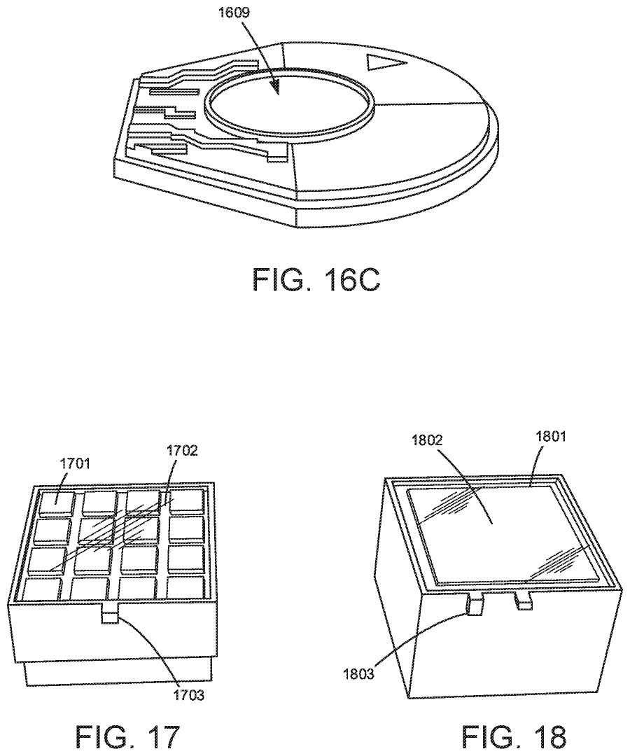

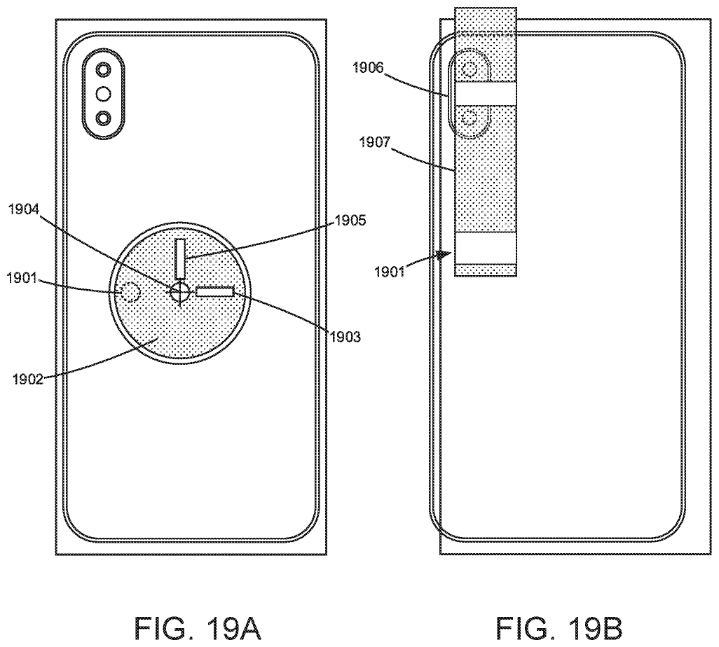

Design incorporating a telescoping read head, mechanized or manual, that extends the useful range for space constrained applications, which may be used with a mobile device are shown in FIGS. 12A, 12B, 13A, 13B, 14A, and 14B. FIGS. 12A and 12B show a hand-held telescoping reader 1201, with handle grips 1231, a reader 1211, and a telescoping unit 1241 to support the reader 1211. FIGS. 13A and 13B show a hand-held telescoping wand 1301, with a reader, also referred to herein as a read-head, 1311, a telescoping unit 1321, cover elements 1331A, and 1331B that encase the reader 1311 shown in the retracted position in FIG. 13B, and open to allow extension of the reader in FIG. 13A. The cover elements 1331A, and 1331B may pivot at a point 1361 on the handle 1351 to open 1341. In FIG. 14A and 14B, a reader on a device with a pistol-grip 1441 is shown with a reader 1411, a telescoping unit 1421, a display 1431 that may be a mobile device. The reader 1411 is activated by the user with a switch 1451. The read-head may contain a camera and/or light source for guiding into location. The read-head may also contain a set of locating features to align a specimen to a camera unit, including mechanical and magnetic means. The read-head could be swapped to measure other unique features including uniqueness of magnetic signature.

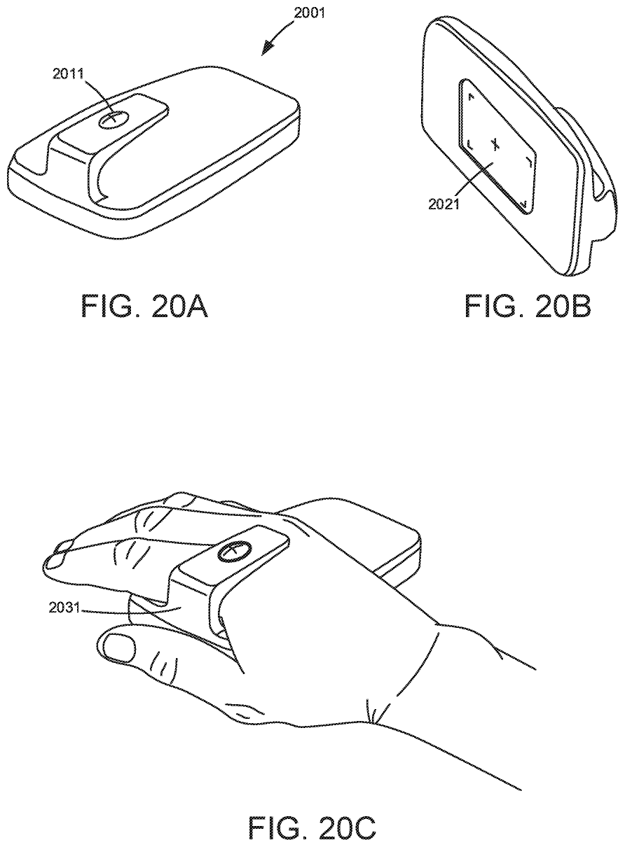

A wrist or forearm reader device 1501 for hands free operation is shown in FIG. 15. The reader 1511 may be connected through Bluetooth interface 1521. A snap to lock attachment 1523 and remove with moldable strap 1531 that may double as temporary handle.

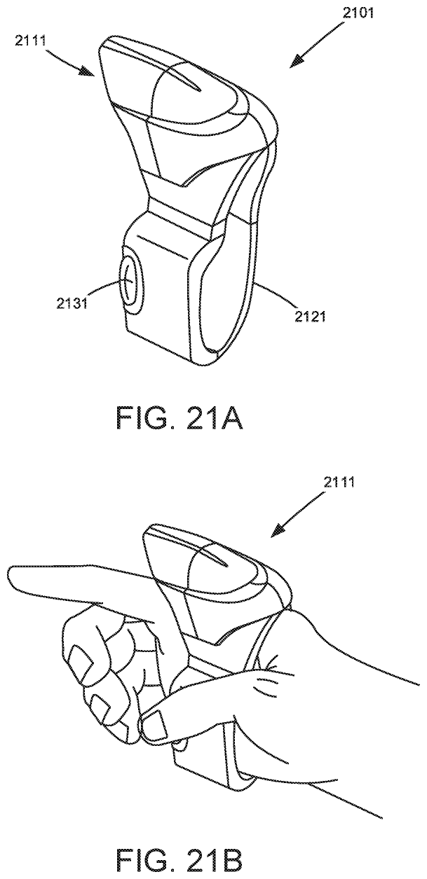

Another embodiment of a reader design is shown in FIG. 16A, 16B, and 16C. A plurality of rotating magnetometers in an array 1604, potentially staggered, to read lanes of pre-magnetized material. The reader head 1609 may be moved against a PUF specimen (not shown). The reader head may be held by normal forces, snap-fit, and/or vacuum force and located by simple mechanical features. The features could be paired as chip/reader.

In the embodiment, the rotational position of the reader 1601 may be controlled by a motor 1602 connected to the reader by a shaft 1603. Other elements include a bezel 1612, a piezoelectric element 1605, a magnetic field camera window 1610, a sensor cover 1607, a locating feature 1606, a faceted optical PUF 1608, a key, SD card, or other reader 1611. Proximity sensing (not shown) could be incorporated to trigger sensor and feedback to user. An optical camera (not shown) could be included to read barcode and/or capture reference image of tag. Proximity allows for RF (e.g., NFC, RFID) to be energized and be read like a barcode. Rotating sensors could be in contained in a wand, gun or probe form. Sensor could be powered by battery or external with data storage, A/D and communication of wide variety.

The magnetic field lines generated by the magnetic particles in the PUF element are closed, and thus a single field strength sensor (e.g., Bz) moving in a straight line will see the magnitude change as function of distance separation and orthogonality of motion to field line. For example, while one sensor, due to alignment, may read a maximum Bz magnitude, a second sensor may read a minimum based on distance.

An array of sensors that measures at controlled distances above specimen where each reading would be distinct. The controlled distance could be manual or mechanical. In the mechanized case, proximity could be sensed and recorded for each measurement. Here, the motion to and from the PUF specimen would measure unique characteristics of magnetic field structure.

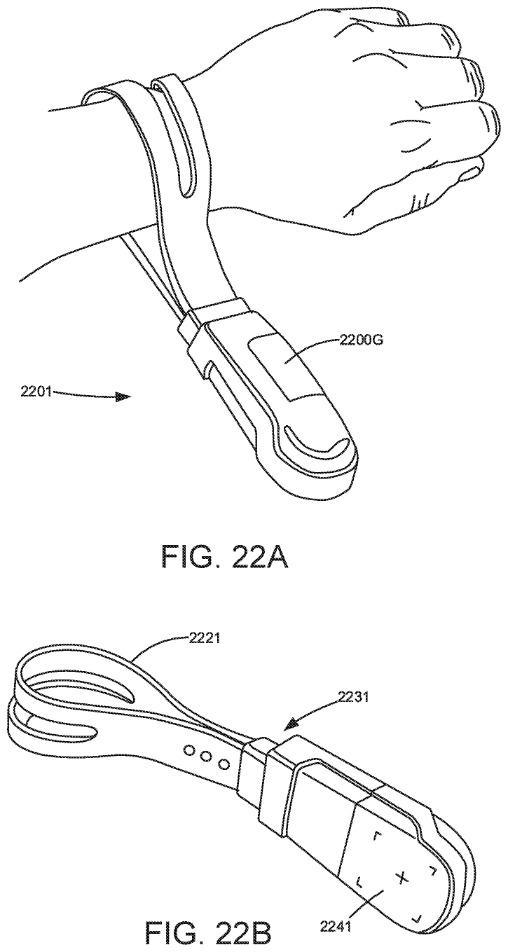

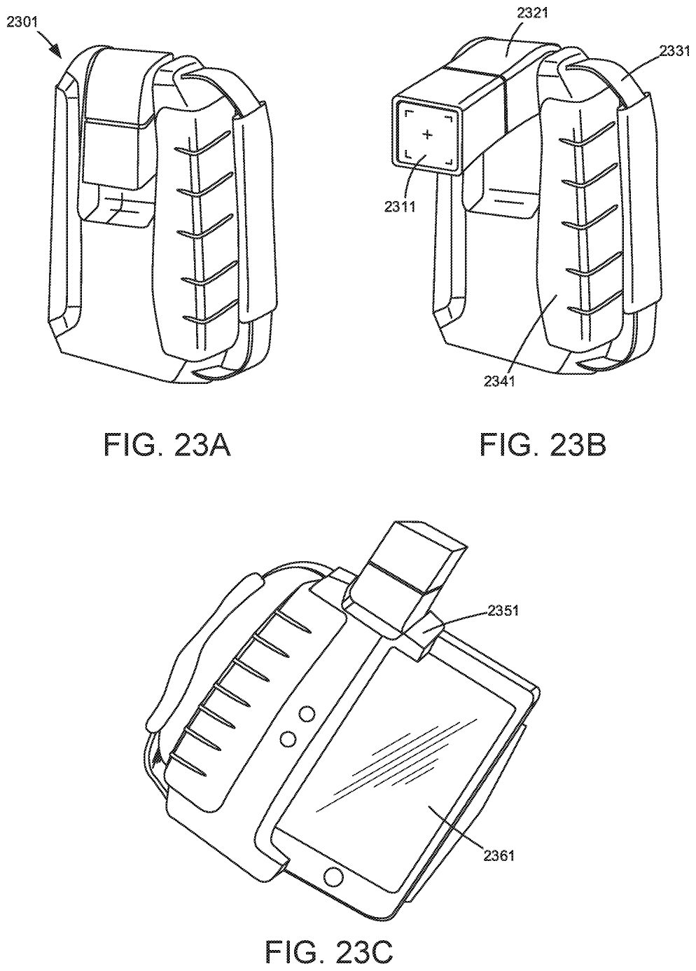

In a modification, shown in FIGS. 17 and 18, a discrete sensor chip 1701 or bare complementary metal-oxide-semiconductor (“CMOS”) array 1801 may be provided. A cover for circuit protection 1702, 1802 may be provided, along with keying 1701, 1801 for orientation and lockout. If symmetric, keyed or without key, the sensor could read in any orientation.

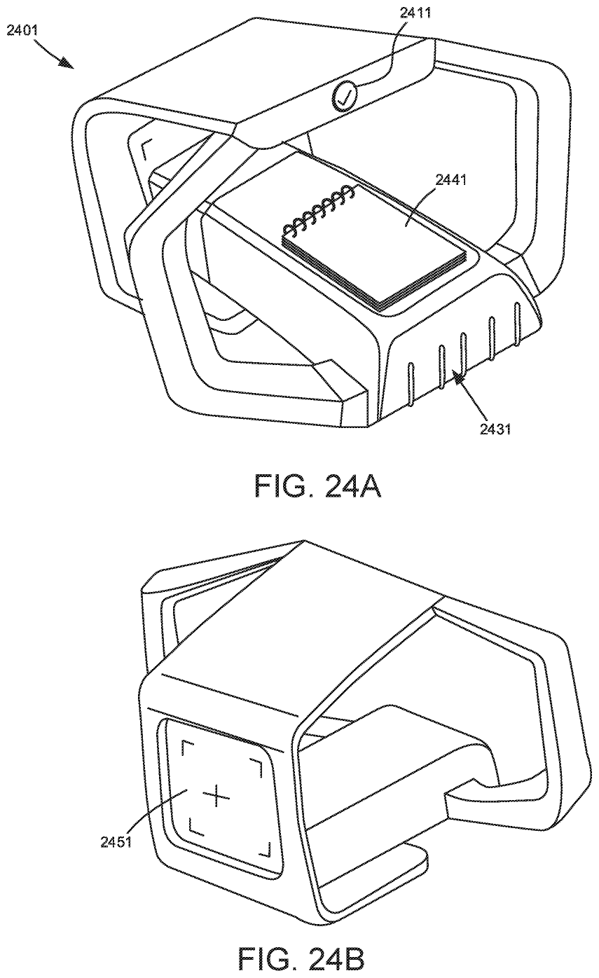

In a further embodiment shown in FIGS. 19A and 19B, methods for using the native mobile device magnetometer 1901 or magnetometer array, potentially staggered, to read PUF elements 1902 is disclosed. A fiducial hole 1903 and fiducial void 1905 may be used for position. A raised fiducial may be used in place of the fiducial void. One device having a pivot 1904 that allows rotation past the magnetometer and a second device 1907 that promotes sliding past the magnetometer. Depending on location of pivot and locating features for sliding. One may use the camera/flash module 1906 as another method to read a PUF tag. This read could also be utilized for velocity or optical data.

Mobile payment methods are growing quickly, so a plurality of sensing provides a means to authenticate prior to purchase. When mobile purchasing is initiated (e.g., ApplePay®), a photo (e.g., object recognition) or RF (e.g., NFC) interrogation of an item under purchase may be made. This step could be made optional and/or required by a device-maker, retailer and/or brand. Levels of authenticity verification required could be function of type/class/price/safety of purchase. Opt-out possible by admin-level user. Valid authentication of item then required to complete purchase.

The mobile device option offers the combination of a magnetometer reading with camera, which can be used for various purposes, and offers the opportunity for authentication verification workflow into mobile payment process. Notably, however, operation would be dependent upon the mobile device, and locating the PUF tag relative to the magnetometer.

Further, the color, brightness, and high resolution of modern mobile device display could be used as the source light to measure a unique optical object. The display could exercise a battery of pattern, brightness, and color. Patterns could be lines, checkboards, concentric circles across any part of specimen surface. Moreover, an engineered light-pipe would transmit light exiting on any and all surfaces back to native camera.

Unique optical objects can include a wide variety of difficult-to-clone embodiments, including but not limited to, speckles, refractive index, occlusions, reflectors, filters, etc., enclosed in transparent medium. Surfaces or optical object could include mirrors, ports, and lenses, to contain and disperse light within transparent medium. Using these unique optical objects, a flash of light could be introduced into a particular location with transmission collected at another location. Internal reflection and absorption will delay in time the transmission from original impulse. Using the optical time domain detection of random internal reflection and absorption, it may be possible to use the native flash of a mobile device as a source.

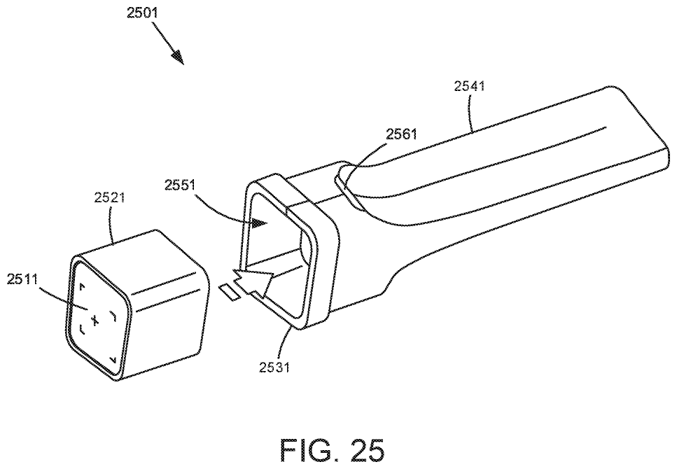

Other reader designs include forms 2001 worn on the hand to improve hand utilization such as in FIGS. 20A, 20B, and 20C. The reader 2001 includes an element to hold the reader on the user's hand 2031, a reader screen 2021, and may have an LED indicator 2011 to indicate operation.

Shown in FIG. 21A and 21B is another design 2101 that is worn on the user's hand. A strap 2121, preferably flexible, secures the device, with the reader screen 2111 is directed by the user's fingers. The reader may have an LED indicator 2131 to indicate operation.

Shown in FIG. 22A and 22B is a final design 2201 that is worn on the user's hand. A strap 2221, preferably flexible, secures 2231 the design, with the reader screen 2241 directed by the user's hand. The reader may have an LED indicator 2211 to indicate operation.

A reader is shown in FIGS. 23A, 23B, and 23C with the reader sensor integrated in a mobile tablet case. A modular read head 2311 with option to add the smart phone or tablet 2311 mounted in a receiving bracket 2351. A rotatable reader 2321 is provided for optimal ergonomics and/or read/head protection. A strap 2331, preferably flexible, secures the device.

A two-handed reader 2401 is disclosed in FIGS. 24A and 24B with a large sensing window 2451 and orientation sensing within reader (not shown) to aid in image capture/processing. The two-handed reader 2401 has handles 2421, a support pad 2431, and an optional work-space area 2441.

Finally, a hand-held device 2501 is disclosed with a reader module 2511 that snap locks into a receiver 2551 of a stylus 2531 with a grip 2541 for the user's hand. The reader may have an LED indicator 2561 to indicate operation.

The present disclosure further describes the systems essential functional blocks of electronics, mechanical configurations and software with additional features needed to read a multidimensional magnetic field on a surface of a randomly generated physical or predetermined parameters of a unique object.

Each functional block has a number of optional or alternative subsystems or features that may be included or excluded from the system. The electronics, mechanical and software subsystems are described in detail with exemplary functions or components. The present invention discusses primarily a magnetic reader system created to read a unique object having a very high entropy (disordered or random) of parameters being measured that has a multi-directional and amplitude magnetic field. It is also important to note that the addition of other authenticating factors will significantly increase the entropy of the system.

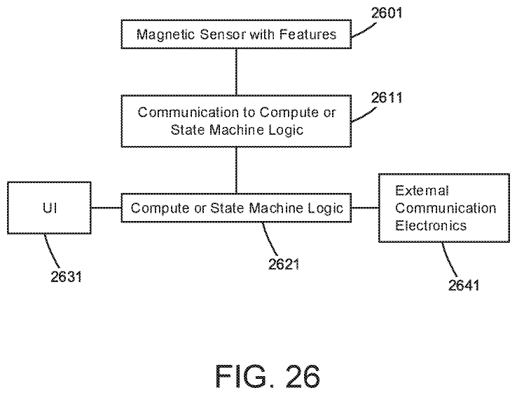

The electronics major blocks are shown in FIG. 26 and consist of a magnetic field measuring sensor with additional features 2601, a communications block 2611 that communicates the sensor data to a compute or state machine function 2621. There are two optional blocks of User Interface (UI) 2631 and external communication electronics 2641.

It is to be understood that each block may be separate entities that are connected together or integrated in to one or any combination of function. This invention includes all of the subsystems and optional functions within each block and are discussed in each major section.

The magnetic sensor with features will preferably have a magnetic field measuring device. This device may be a Hall effect sensor as that has at least 2 orthogonal direction (2D) magnetic sensors in a rectangular array to measure over a surface of a unique object. The 2D direction of the sensor would be preferably two orthogonal directions that are tangential to the measuring surface. A preferred configuration would include at least 3 orthogonal direction (3D) magnetic sensor array. A 1D sensor may be augmented with addition factors like capacitive or optical sensing would approach the 2D or 3D system for the entropy.

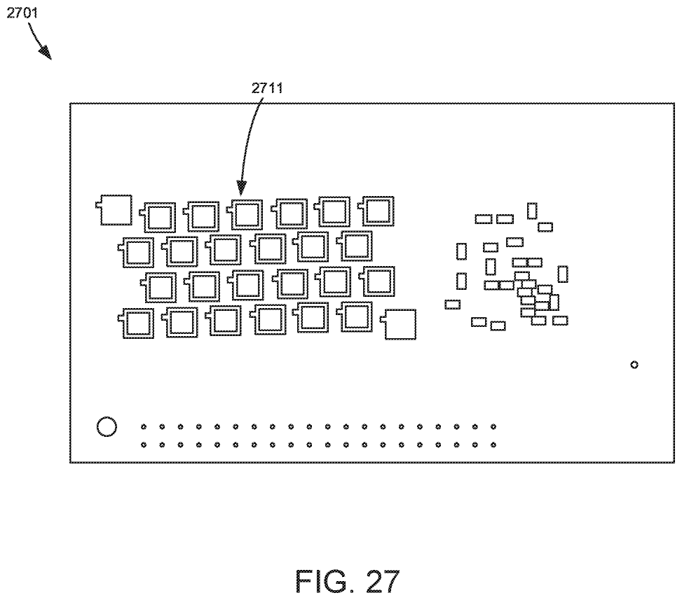

There exist many techniques for measuring magnetic fields. One implementation is a Hall effect sensor array described above, comprised of discrete sensors that are in a rectangular or staggered pattern. FIG. 27 shows locations 2711 of discrete magnetic field sensors in the context of a 2701 PCBA with array of 3D hall effect sensors. This is a multi-sensor PCBA where the array of sensors are positioned in such a way that they can be used for both enrollment and stationary reading applications. Each sensor is staggered from its neighbor by about 0.2 mm in one direction. Therefore, each row of sensors can cover about 1 mm of space while enrolling a PUF strip. Small indices of the reader PCBA or PUF strip can be made with multiple passes to enroll an entire surface of the PUF strip. As the sensor industry evolves the packaging sizes can be closer together.

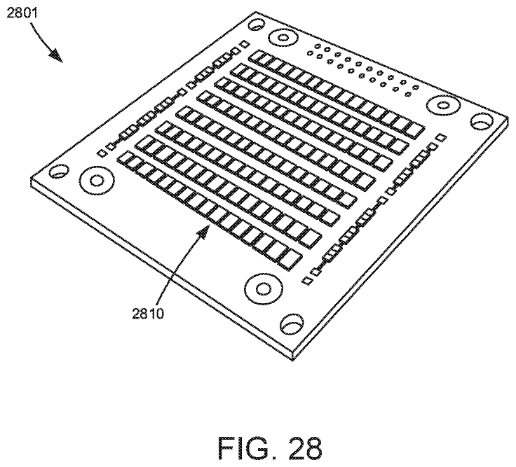

One option is a fully integrated array where all the sensors are present in a wafer die. The array of sensor groups can be small in number from 1 to 12 or a larger array of 96×96 or 128×128, for example. Arrays of discrete or dual Hall effect sensors 2810 on a PCB are available, from Matesy GmbH, for example, which offers an array 2801 shown in FIG. 28 as well as a staggered array of a similar nature. However, the Matesy GmbH product does not include additional factors.

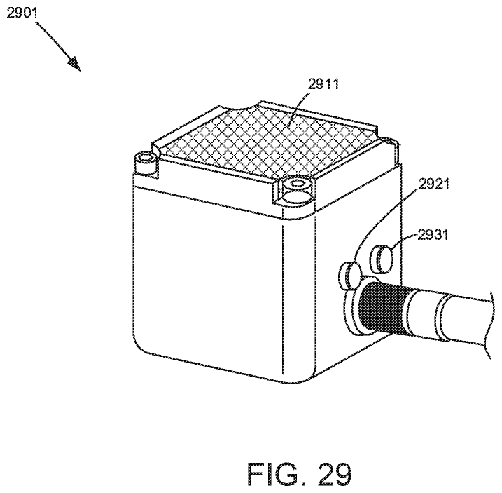

While this example is an array of 3D hall effect sensors, the sensors do not have the pitch that is preferred nor include any sensing beyond the magnetic field sensors. A prior art device that is a sensor containing a 1D magnetic field sensor over a 128×128 array 2911 is a one-axis magnetic field camera 2901 that has a USB interface to export the data shown in FIG. 29, with power 2921 and data 2931 indicators.

These sensors, however, are not sufficient to solve the problems of this invention with the desired entropy. Micro electro-mechanical system (MEMS) technology may be used as an alternative or in conjunction with a Hall effect sensor to perform field measurements. If the MEMS magnetic field sensor is used, the 2D field direction of the sensor would be preferably two orthogonal directions that are tangential to the measuring surface. A capacitive feature can be added to the magnetic field sensor. The geometry of a MEMS structure has a current traveling around the edge of a cantilevered flexing member. This creates Lorentz force that deflect the beam due to magnetic fields that are in the plane of the beam and normal to the connector bar between the two elements connected to the main body. These can be oriented at 90 degrees within the plane to give the preferred tangential magnetic field components.

In a similar way, an acoustical sensing device can be incorporated by using a piezoelectric material that would be used to interrogate the surface to determine the locations of the varying materials within the unique object. The sensor geometry may be distributed in rectangular, square, staggered or irregular pattern.

Integration of a light emitting, optical camera sensor system is also envisioned to be a method to read the uniqueness of the object with optical parameters present.

The data read from each of the sensors may be transmitted by a serial, parallel, or shared memory interface. Some applications will include encryption methods within the sensor electronics before sending the information the data tough the interface. The shared memory will allow the sensor to automatically transfer the data to a multi-ported memory that would allow the compute block to access the data independent of the flow of the information from the sensor. A system on a chip with integrated sensors would be the most compact and cost effect method to perform these functions.

Alternative sensor methods include the use of a single or low count 3D sensor on a traveling system to read the surface of the unique object. A plurality of rotating magnetometers in an array, potentially staggered, to read lanes or pre-magnetized material. Read head moved against specimen. Held by normal forces, snap, and/or vacuum and located by simple mechanical features. Features could be paired as chip/reader shown in FIGS. 16A-C. Proximity sensing (not shown) could be incorporated to trigger sensor and feedback to user. Optical features 1608 could be included to read barcode and/or capture reference image of tag. Proximity allows for RF (e.g. NFC, RFID) to be energized and read like barcode.

Rotating sensors could be in contained in a wand, gun or probe form. Sensors could be powered by battery or external with data storage, A/D, and communication of wide variety.

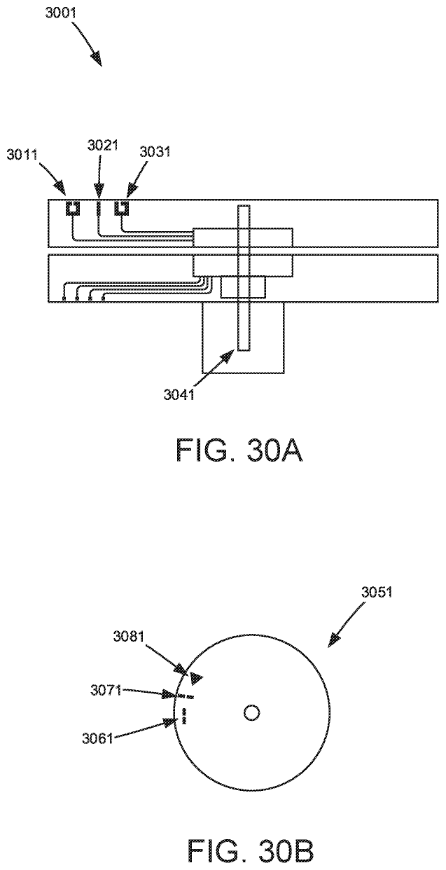

Yet another sensing technology would include a high-speed rotation device for inductive sensing R 3011, Θ 3021, Z 3031 using VCR like technology shown FIGS. 30A and 30B. This is a 3-channel device that spins the top half of the sensor 3001 containing magnetic field inductors oriented in 3 orthogonal directions. The preferred directions would be in the radial direction (R) 3011, direction of the rotation (Θ) 3021, and the normal (Z) 3031 direction. In FIG. 30B top view 3051, the top location for the inductive pickup 3061 in the Θ rotational direction is shown that is associated with 3021. Further, the top location for the inductive pickup 3071 in the R radial direction is shown that is associated with 3011. Finally, the top location for the inductive pickup 3081 in the Z normal direction is shown that is associated with 3031.

The signal may be received in the upper half and amplified or magnetically coupled to the stationary side of the device. A DC or stepper motor 3041 may be used to spin the top half. The sample may be moved over the rotating sensor or the sensor assembly may be translated over the unique object to be mapped. This would require a translating platform or arm (not shown) to move the rotating wheel over the surface. A two jointed linkage (not shown) could also move the inductive or hall effect sensor in a sliding arc. This would require two prime moving devices to create the motion. This could also be a geared system with one motor that would spiral or oscillate across the surface. The mechanical block section will discuss in more detail.

The communication from the sensor to main compute logic (Central Processing Unit CPU) 2611 can be formed by serial or parallel communications. The communication may be encrypted or unencrypted by currently available or new methods. The hardware interface may be as simple as an RS232 or I2C bus to a full parallel data link. Other interfaces like SPI or USB depending of the payload or security needed. As previously discussed, a multiport RAM or DMA (Direct Memory Access) may be used to transmit the data. The communications may be a direct continuous data stream or a hand-shake with instructions sent to the sensor and data returning. The communication may instruct the sensor to give various resolutions or patterns of data depending on the application.

The compute or state machine logic electronics 2621 performs the required processing on the data from the sensor and may perform analysis of the data to determine if the unique object is a matched item to a previously enrolled unique object. In the preferred case the processing is to determine key features of the unique object that can be processed in another location to determine if the unique object has been previously enrolled. The compute block may include a CPU, Graphics Processing Unit (GPU), Micro Processor (μP), gate array, or digital logic to perform this function. The system would preferably have access to a timing functions, RAM and ROM memory. These will control the sensor through the sensor communications interface as well as any motors, actuator or sensors.

The compute function also controls the User Interface (UI) to instruct the operation of the steps to use the reader and output the preliminary or final results of the scan of the unique object. The UI 2631 may just be a few LED indicators or display with audio or haptic feedback.

The compute function also controls the external communications 2641 that may be available over both wired and wireless interfaces. Wired interfaces may include a proprietary encrypted serial or parallel method or USB, RS232, Ethernet. The wireless interface may include a WiFi, Cellular, Bluetooth or similar technique. The device to communicate may also be a removeable memory that carries encrypted or nonencrypted information.

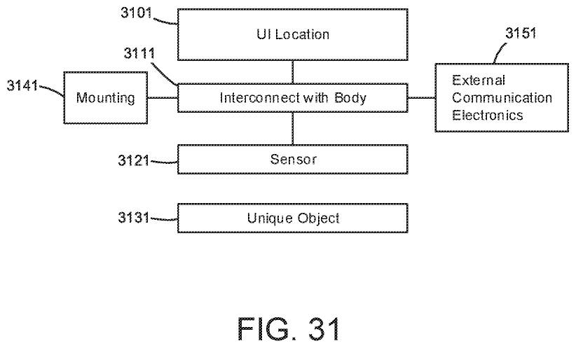

The mechanical system consists of several blocks that can work in conjunction with each other as shown in FIG. 31. The described systems may be configured with any combination of the features or connections to each other. The system boundaries are not necessarily limited to the configurations shown. As shown, the body 3111 has a UI location 3101, and may have mounting 3141 and external communication electronics 3151. The body 3111 has at least one sensor 3121 for measuring properties or features of unique object 3131.

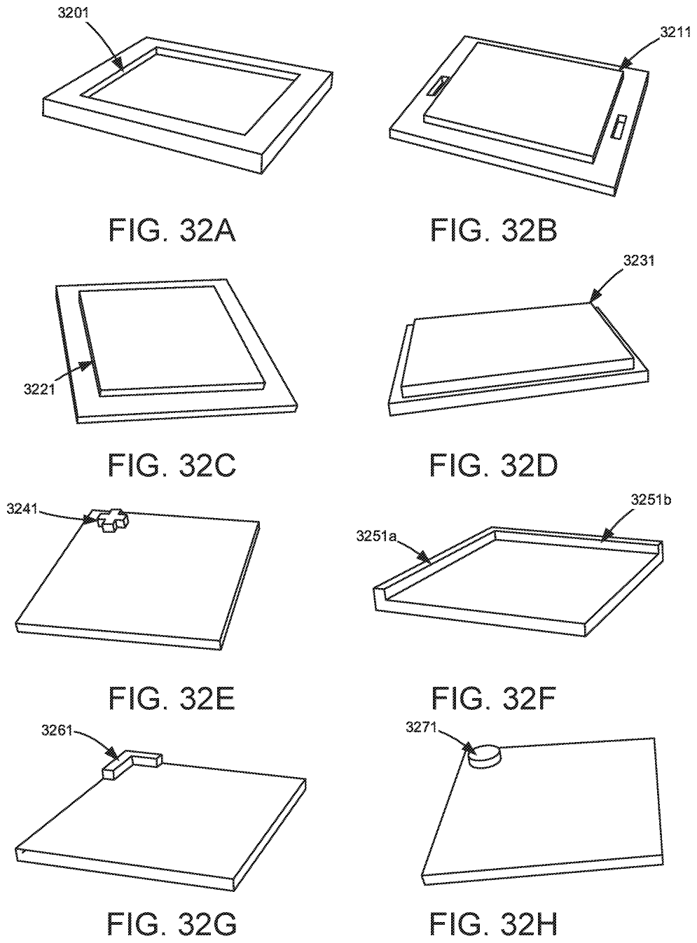

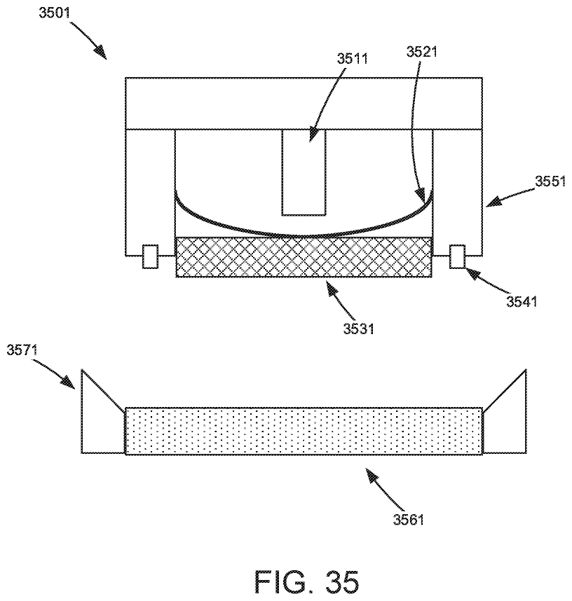

The unique object 3131 typically has a flat surface; however, there are unique objects that may be curved, perforated or arbitrarily shaped shown in FIGS. 32A-H. The system has to allow for a close proximity of the sensor 3121 to the unique object 3131. The surfaces of the sensor 3121 need to be protected from damage by the packaging or cover of the sensor when in contact with the unique object 3131. This allows for direct contact between the unique object and the sensor part of the reader system. The sensor 3121 will be connected to the body 3111 of the reader in various ways. It may be permanently fixed to the main body or detachable via a cable (not shown) or battery operated with a wireless or memory device (not shown) to communicate or save the data. This enables the sensor to be oriented to the unique object. The unique object 3131 may have features in the surface used to either align the object to the sensor or be an interlocking mechanism that only allows the reading of a specific family of unique objects, 3201, 3211, 3221, 3231, 3241, 3251a-b, 3261, 3271, for example. The unique object may have slots or holes that the sensor would have the mating pins or ridges that interface to the unique object. This may align the object for a specific location to be align with a tight tolerance to make repeated reads in one location or to keep the sensor from sliding while reading. However, another application would be to allow the tolerance to be loose so that the there are many possible read locations, but the features would assist in holding a specific location while reading. Movement during the read process would distort the data being taken. This alignment feature will be referred to as a being a “keying feature” that can be used for both the loose and tight alignment. FIG. 35 shows a keying feature with a guide feature 3571 for a magnetic particle region 3561.

The sensor 3121 can have the opposite or inverted feature to the unique objects shown such as 3201, 3211, 3221, 3231, 3241, 3251a-b, 3261, 3271. This would facilitate the alignment or key function to only allow some unique objects to be interfaced. It is also understood that the sensor may have a larger or smaller interface feature that would allow a flat interface to the surface. For example, the raised cross 3241 and cylinder feature 3271 would allow a flush fit to the surface of the reader if the reader alignment feature was a large enough so that the cross and/or cylinder would fit inside.

The surface of the unique object may have a random or predetermine surface texture that may be detected by a for measuring device.

The sensor can be a small integrated circuit or printed circuit board (PCB) that measures 1D, 2D or 3D magnetic fields as well and other observable parameters. These sensors, as stated, may be a single location, line or array geometry that are fixed or movable to measure the intended unique object in any combination of direction of measurement. FIGS. 20-22 show a number of hand-held reader systems that have a flat surface where the sensor may be permanently embedded on a flat surface to read a flat unique object. The sensor may also have the keying feature built in. The keying features can be an overlay system that are removable or permanently attached to the sensor or reader body.

The sensor may also be detachable as shown in the FIG. 25. A hand-held device 2501 is disclosed with a reader module 2521 that snap locks into a receiver 2551 of a stylus 2531 with a grip 2541 for the user's hand. The reader may have an LED indicator 2561 to indicate operation. The reader module 2511 with a sensor 2511 may be connected to the reader body by a cable or wireless communication. The reader may also have memory that allows the data to be transferred with the sensor is docked to the body of the reader.

A sensor may require a calibration function to allow sensor and external background offsets to be removed. This can be accomplished by enforcing a requirement that the magnetic field be read when not in close proximity to the magnetic source. A dielectric cover (not shown) that does not contain a hard-magnetic material (any material that will maintain a residual magnetic field like iron) may be used. The cover may be hinged, sliding, or attached over the sensor to provide the separation between the sensor and external magnetic sources. An interlock, switch or other detection means can be used to verify the cover is in place before reading the residual magnetic fields. If a very low residual field is desired, then a soft magnetic material (any material with a high relative permeability that does not retain a residual magnetic field like a ferrite material) may be placed near the sensor surface and can be attached or integrated into the dielectric cover.

As previously stated, multiple sensing techniques may be combined to increase the detection of an object's uniqueness by combining sensor technologies. FIG. 9 shows an optical camera 911 located adjacent to an array of discrete surface array 3D magnetic field sensors 921. It is to be understood that the camera may be reduced in size than shown and placed adjacent to or surround by the magnetic field sensor. The sensing combinations may be any of the sensing methods previously stated including but limited to capacitive (electric field dynamic, quasi-static or static), inductive (dynamic magnetic), ultrasonic, optical, hall effect (static or dynamic) magnetic field, pressure, acoustical or RF scattering. These may be integrated into one or more ICs and brought together on one or more PCB.

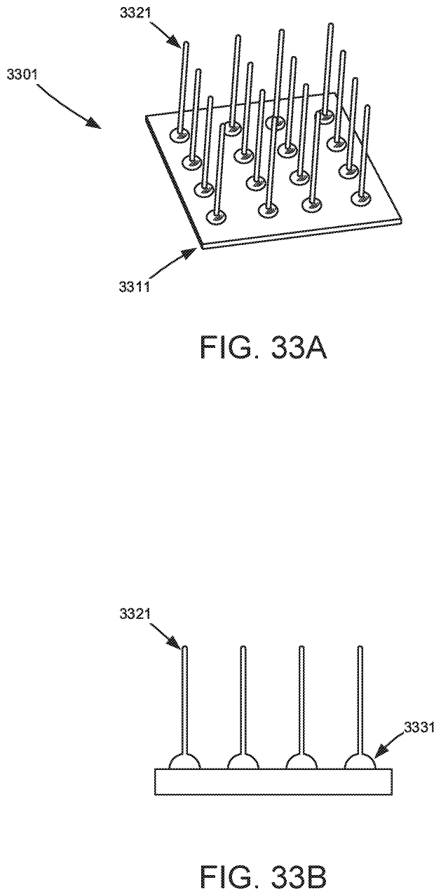

A force pattern can be measured by a MEMS device 3301 shown in FIGS. 33A-B of silicone cilia hairs 3321 in a silicone substrate 3311. The bonding location of the cilia hair 3331, i.e., the cilia base pivot, is a pivot point that distributes the cantilever force over an area of the substrate that is also the pivot that that converts torsion forces into measurable quantities on the substrate. One or more the magnetic sensors can be replaced with the surface force measuring sensor in FIG. 33A to integrate the surface texture while measuring the magnetic field.

The modified VCR head in FIG. 30A-B sweeps out a circle as it spins. This results in a medium entropy signal measured across an arc of a unique object. It the head is translated across the surface then a larger area can be measured. This translation can be done with a platen (not shown) and a lead screw to progress the head over a surface. The rotating head can also be moved on an arm system (not shown) that uses a cam to push the head for the area. This is very similar to a hard disk drive magnetic read-head that is indexed to the track of a disk. A double-jointed arm can sweep a 3D hall effect or inductive pickup over the surface.

The sensor may be implemented in many ways to the body of the reader. FIGS. 12-14 show many forms that may be used with features. In particular, FIG. 15 shows a sensor, computing, and communications system that can be worn on the wrist much like a smart watch. The wrist or forearm reader device 1501 for hands free operation is shown. The reader 1511 may be connected through Bluetooth interface 1521. A snap to lock attachment 1523 and remove with moldable strap 1531 that may double as temporary handle. In this configuration a battery may be used to power the system and the UI is limited to a set of LEDs or small screen on an adjacent side to the sensor. The system can communicate over a wireless interface to a cellular phone or base reader device. The system may be charged by wired or wireless methods. The wired method pay plug directly into a phone or PC for mobile use or a networked system found in a factor setting.

The reader body may also incorporate a cellular phone into the system to share the computing and communications functions, as shown in FIG. 16. There, a plurality of rotating magnetometers in an array 1604, potentially staggered, to read lanes of pre-magnetized material. The reader head 1609 may be moved against a PUF specimen (not shown). The reader head may be held by normal forces, snap-fit, and/or vacuum force and located by simple mechanical features that provide an alignment indication. The features could be paired as chip/reader.

In the embodiment, the rotational position of the reader 1601 may be controlled by a motor 1602 connected to the reader by a shaft 1603. Other elements include a bezel 1612, a piezoelectric element 1605, a magnetic field camera window 1610, a sensor cover 1607, a locating feature 1606, a faceted optical PUF 1608, a key, SD card, or other reader 1611. This configuration allows some preprocessing in the body of the reader and communications to the phone, which can be a two-way communication. An application of the phone can then receive the data via the wired or wireless link to be further processed. The phone can then communicate the key data over the cellular or WiFi to the backend system for completing the authentication. The software and backend section will discuss more about those functions.

FIG. 23 shows a removable modular read head option that can be added a smart phone or tablet, additional battery capacity shared with mobile. Rotatable reader for optimal ergonomics and/or read/head protection.

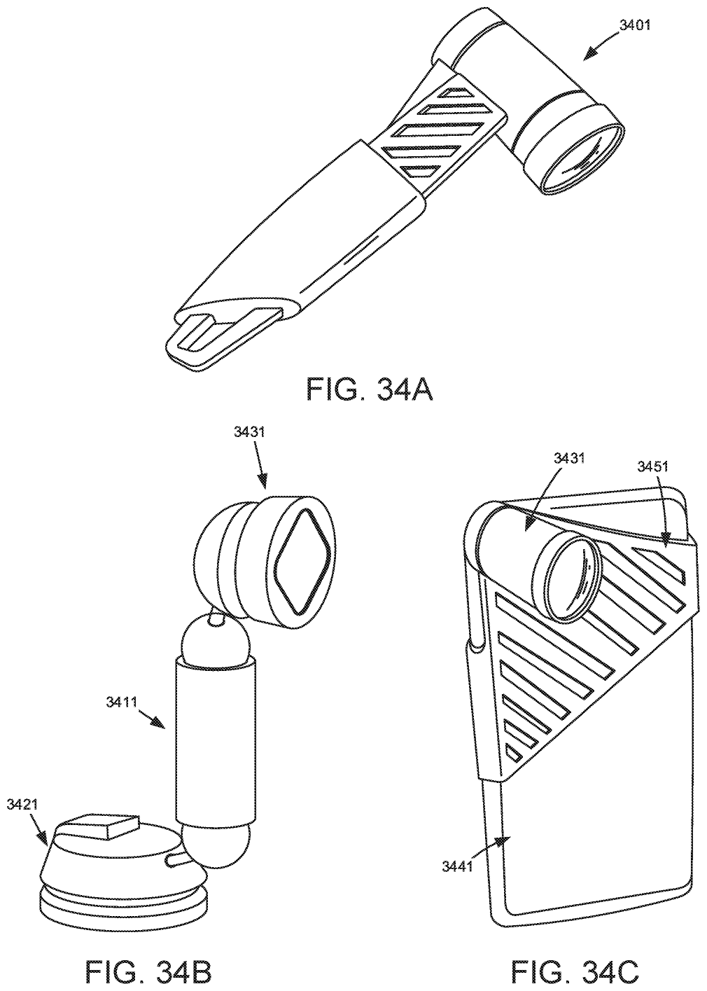

Any of the readers may be positioned via a linkage system to position the reader to be convenient to the use to interact with the UI or put the reader in the correct position to read the unique object. FIG. 34 shows articulated systems to mounting or managing the reader system. FIG. 34A shows a removable reader 3401 attached to an extendable handle 3405. FIG. 34B shows as reader 3431 mounted to an articulating arm 3411 attached to a base 3421. FIG. 34C shows a modular reader 3431 mounted on a frame 3451 for connecting to a mobile phone 3441. The positioning systems shown may be manual, actuated or robotically controlled for autonomous connection to the unique object.

The sensor may incorporate a surface alignment feature 3501 as well that provides an alignment indication. FIG. 35A-B shows a spring action method to promote equal pressure of the sensor IC or PCB 3531 to the magnetic particle region of the unique object 3531. The leaf spring 3521 is used to apply a known downward force while the telescopic reader body is brought into contact with the unique object 3561 by guide features 3571. The spring is depressed until the force contact switch 3511 is triggered indicating that sufficient force has been applied. The integration option of a non-skid material 3541 on the frame 3551 will help to keep the sensor from translating or rotating during the read time.

FIG. 24 shows a reader body that has a transparent window that allows a user to visually see fiducials to assist with locating the reader sensor over the target unique object. This version may also have a handle that can vibrate to give haptic feedback as well at indicator light and audio sound that indicates that the unique object is able to or has been read.

As shown in FIGS. 12-15 and 20-25, the user interface can be a LCD or some kind of video screen to individual LED indicators as part of the reader body. As discuss, the UI may also be a phone, PC, Pad or other mobile or stationary electronic device. The device may be in direct contact or integrated into the reader body or separate with a communication method that may include wired or wireless as previously discussed. The UI may be part of an existing phone, PC or tablet that is attached by a wired or wireless communication system as previously discussed.

The body of the reader may have a permanently attached cable that connects to a second device to deliver the data needed to operate. This cable may have a connector system or wired directly into the second device. The reader may also have an input/output connector on the surface like a USB, serial device or custom interface to be connected to the second device. The reader may have a removable memory connector to be used to transfer the data to an external device. This interface would allow the second device to be a point of sale terminal or lock system to gain entry to a secure room or building.

We claim:

1. A system comprising:
one or more magnetic sensors measuring the magnetic field in at least two orthogonal directions tangential to a surface of an object;
the one or more magnetic sensors distributed as an array over the object surface;
an alignment indication for the one or more magnetic sensors with respect to the object surface;
the one or more magnetic sensors communicating over a link to a computing system; and
the computing system analyzes data for the entropy of the object, wherein the computing system indicates to a user through a user interface display characteristics of the object.

2. The system of claim 1, further comprising micro electro-mechanical field sensors for measuring a surface texture of the object.

3. The system of claim 1, wherein the one or more sensors are housed in a reader body.

4. The system of claim 3, wherein the reader body has an opposite or inverted feature of the object to assist in the alignment indication.

5. The system of claim 4, wherein the feature is a single edge for alignment indication.

6. The system of claim 4, wherein the feature is two or more edges that aide alignment indication.

7. The system of claim 4, wherein the feature is a shape that the sensor fits over.

8. A high-speed rotation device for magnetic field inductive sensing comprising:
at least three magnectic field inductors in the R, Θ, and Z direction;
a motor to spin a sensor containing the magnetic field inductors;
inductive pick-ups corresponding to the magnetic field inductors; and
magnetic coupling of a signal received from the inductive pick ups to the stationary side of the device, wherein an object may be moved over the rotating sensor to be mapped.

9. A magnetic field sensing device system comprising:
one or more sensors measuring the magnetic field in at least two orthogonal directions tangential to a surface of an object;
the one or more hall effect sensors distributed as an array over the object surface;
the hall effect sensor communicating over a link to a computing system; and
the one or more sensors incorporate a surface alignment feature with a leaf spring used to apply a known downward force against a unique object, wherein the spring is depressed until a force contact switch indicates that sufficient force has been applied.

10. The system of claim 9, wherein a non-skid material on a sensor frame will help to keep the sensor from translating or rotating during the read time.

11. A method of aligning a sensor with the surface of an object comprising:
bringing a reader body housing one or more sensors into contact with an object;
depressing a spring in the reader body; and
triggering a force contact switch when sufficient force has been applied to the spring.

12. The method of claim 6, wherein the spring is a leaf spring.

13. The method of claim 6, wherein the reader body housing is telescoping.

14. The method of claim 6, wherein guide features are used to bring the reader body housing a sensor into contact with an object.
